(19) United States
(12) Patent Application Publication
(10) Pub. No.: US 2024/0077789 A1
(43) Pub. Date: Mar. 7, 2024

(54) IMAGING OPTICAL SYSTEM

(71) Applicant: Nextlens Switzerland AG, Dietikon (CH)

(72) Inventors: Manuel Aschwanden, Allenwinden (CH); Ilias Bosdas, Zürich (CH)

(73) Assignee: Nextlens Switzerland AG, Dietikon (CH)

(21) Appl. No.: 18/460,552

(22) Filed: Sep. 3, 2023

(30) Foreign Application Priority Data
Sep. 2, 2022 (DE) 10 2022 122 327.2

(51) Int. Cl. G03B 17/17; G02B 3/14

(52) U.S. Cl. CPC G03B 17/17; G02B 3/14

(57) ABSTRACT

The invention relates to an imaging optical system with a tunable optical component, which comprises a first optical surface, a second optical surface and a deformable internal space between the first optical surface and the second optical surface, which internal space is filled with a transparent liquid, and wherein an optical property of the tunable optical component is adjustable by altering a shape of the internal space, and with a first folding element which is mechanically coupled to the tunable optical component such that a relative displacement between the first folding element and the tunable optical component causes a change of the optical property of the tunable optical component and with a second folding element that is arranged in series with the tunable optical component and the first folding element within an optical path of the imaging optical system.

### CROSS-REFERENCE TO RELATED APPLICATIONS

Benefit is claimed to German Patent Application No. 10 2022 122 327.2, filed Sep. 2, 2022, the contents of which are incorporated by reference herein in their entirety.

### FIELD

The invention relates to an imaging optical system.

### BACKGROUND

Imaging optical systems are basically known and useable in various devices such as mobile phones. It is desirable that an imaging optical system has a compact design and at the same time allows the adjustment of at least one optical parameter, to improve the quality of a captured image. It is an object of the present invention to suggest an imaging optical system with which these objectives can be achieved.

The objective is solved by an imaging optical system described herein.

### SUMMARY

According to the invention, the imaging optical system comprises a tunable optical component with a first optical surface, a second optical surface and a deformable internal space between the first optical surface and the second optical surface. The internal space is filled with a transparent liquid. An optical property of the tunable optical component is adjustable by altering a shape of the internal space. The imaging optical system further comprises a first folding element which is mechanically coupled to the tunable optical component such that a relative displacement between the first folding element and the tunable optical component causes a change of the optical property of the tunable optical component. A second folding element is arranged in series with the tunable optical component and the first folding element within an optical path of the imaging optical system.

The invention is based on the finding that an imaging optical system with the above-mentioned features can have a compact design. At the same time, at least one optical property can be adjusted during image acquisition in a simple manner with regard to the structure of the imaging optical system.

According to the invention, the tunable optical component has at least one optical property, which can be adjusted by altering the shape of the internal space. The invention is not limited to a specific design of the tunable optical component, or which optical property is adjustable. Therefore, it is within the scope of the invention that the tunable optical component is a tunable lens. Preferably, the first optical surface and the second optical surface are each at least partly transparent in an area that is arrangeable in the optical path of the imaging optical system. Furthermore, it is preferred that the first optical surface and the second optical surface are relatively displaceable to each other. A deformation of the internal space can therefore basically take place by completely or partially displacing the first optical surface and the second surface relative to each other. By deforming the internal space, an optical property of the tunable optical component is adjusted such that the quality of a captured image may be improved effectively.

Preferably, in at least one state of the tunable optical component, the first optical surface and/or the second optical surface are flat and spaced parallel to each other. It is also within the scope of the invention that, in at least one state of the imaging optical system, the first and/or the second optical surface each have a curved shape. The invention is not limited to a specific transparent liquid, which, in a simple embodiment, may be an optical oil or another suitable liquid. By deforming the internal space, it is possible to influence a light beam entering the optical imaging system along the optical path before it hits the first folding element.

According to the invention, the first folding element can be considered as an optical component that deflects and/or diverges the path of a light beam. Preferably, the first folding element defines a first light entry axis and a first light exit axis that enclose a folding angle of at least 30°, preferably at least 45°, highly preferred 90°.

According to the invention, a relative displacement and/or a relative rotation between the first folding element and the tunable optical component causes a deformation of the internal space. A mechanical coupling between the first folding element and the tunable optical component makes it possible on the one hand to avoid additional force-transmitting elements by means of which the internal space may be deformed.

A light beam deflected by the first folding element can be directed to the second folding element. The second folding element can also be considered as an optical component that deflects and/or diverges the path of a light beam. Preferably, the second folding element defines a second light entry axis and a second light exit axis that enclose a folding angle of at least 30°, preferably at least 45°, highly preferred 90°.

Preferably, in at least one state of the optical imaging system, the first light exit axis is parallel to the second light entry axis due to the arrangement of the first and second folding element in series within the optical path of the imaging system.

The arrangement of the tunable optical component, the first folding element and the second folding element in series with respect to the optical path enables a flat design for both the optical imaging system and the particular device, in which the optical imaging system is useable, e.g., a mobile phone. This is because the imaging optical system may be arranged such that the light enters the imaging optical system essentially perpendicular to a main extension plane of the device and is deflected such that it runs essentially parallel to the main extension plane between the first and second folding element within the imaging optical system. Therefore, a plurality of components, especially optical components such as rigid lenses, can be arranged between the first and second folding element in a part of the optical path that runs parallel to the extension plane. Therefore, a flat design of the device, more particularly the mobile phone, is not affected by the arrangement of a plurality of optical components within the optical path.

In a preferred embodiment of the imaging optical system, an image sensor is arranged within the optical path, wherein the tunable optical component and the image sensor are essentially arranged parallel to each other and wherein the optical path is preferably folded by essentially 180°.

Typically, it desired to both minimize the thickness of the imaging optical system and especially the device, in which the imaging optical system is used, and to maximise the area of the sensor. These objectives, however, are in conflict in previously known imaging optical systems, since a large sensor is in general not compatible with an overall compact design of the imaging optical system. However, the preferred embodiment described above allows to provide a large sensor within the optical system with a compact design. This is due to the fact that a deflection of the optical path by the first and second folding element makes it possible to arrange the sensor essentially parallel to the main extension axis of the optical system and in particular of the mobile device. Therefore, a large sensor area does not negatively affect the flat design of the imaging optical system and the device, in which the imaging optical system may be used. Preferably the optical path extends at least partially perpendicular to an entrance pupil of the optical imaging system.

Preferably, a depth of the imaging system is not larger than 7.2 mm and/or a width of the imaging sensor is at least 6 mm.

In a preferred embodiment of the imaging optical system, the first folding element is moveably mounted with respect to the tunable optical component. The imaging optical system comprises an actuator with a magnet and a coil, wherein the magnet is mechanically coupled to the tunable optical element and the coil is mechanically coupled to the first folding element. The coil and the magnet interact such that an electric current in the coil causes a relative displacement between the first folding element and the tunable optical component in order to change the optical property of the tunable optical component.

According to the embodiment described above, the imaging optical system comprises an electromechanical actuator. Said embodiment is in principle not limited to how the magnet is coupled to the tunable component and how the coil is coupled to the first folding element. It is only relevant that this is a so-called moving coil arrangement, in which the coil and the first folding element coupled to the coil are movably mounted relative to a fixed part of the imaging optical system, in particular the magnet and the tunable optical component.

Contrary to the usual design practice, the moving coil arrangement is associated with an increased effort in its electrical contacting, because a source for electrical energy is mostly fixedly arranged in relation to the moving coil. However, investigations by the applicant have shown that such a moving coil arrangement, in particular in contrast to a moving magnet arrangement, allows a faster adjustment of the first folding element due to lower moving masses.

In a preferred embodiment, the imaging optical system comprises a lens shaping element with a circumferential edge, which at least partially extends around the optical path and is designed to interact with the first optical surface of the tunable optical component. A transparent element, particularly a glass window, is essentially flat and attached to the second optical surface of the tunable component and the first folding element. The lens shaping element is mechanically coupled to the magnet and the transparent element is mechanically coupled to the coil, such that the electric current causes a displacement of the transparent element with respect to the lens shaping element in order to change the optical property of the tunable optical component.

According to the preferred embodiment described above, the lens shaping element and the transparent element are arranged on opposite sides of the tunable optical component. The transparent element is used to transmit a movement and/or a force of the coil to the tunable component via the second surface and to press it against the lens shaping element. Depending on the geometry of the lens shaping element, the first surface may be displaced and/or deformed in the area of the optical path. In this way, the optical property of the tunable optical component can be specifically influenced.

Preferably, the first optical surface and the second optical surface each are deformable membranes. In this case, an adjustment of the transparent element causes a deformation of the second optical surface and a resulting change in the internal space increases the pressure in the transparent fluid. This causes a curvature of the first optical surface, which leads to a change in the optical property of the tunable optical component.

In a preferred embodiment, the coil is arranged on a coil carrier and the magnet is arranged on a magnet carrier. An elastic bearing element is mechanically coupled to the coil carrier and the magnet carrier.

According to the preferred embodiment described above, the coil carrier is a structural element that is designed to support the coil within the imaging optical system. Correspondingly, the magnet carrier is also a structural element that serves to support the magnets. Preferably, the magnet carrier is connected or integrated into a housing of the imaging system. The elastic bearing element supports the coil carrier and the magnet carrier so that they can move relative to each other. If the coil carrier is displaced relative to the magnet carrier, the elastic bearing element is deformed and exerts a restoring force and/or a restoring torque opposing the relative displacement. Depending on the stiffness of the bearing element, it is possible to define a relative position between the coil carrier and the magnet carrier, into which both carriers return in a non-actuated state of the actuator. Preferably, the elastic bearing element is an essentially flat spring. In at least one state, the spring may extend essentially parallel to the tunable optical component.

In a preferred embodiment, the elastic bearing element defines a linear axis of motion for the relative displacement between the tunable optical component and the first folding element.

Investigations of the applicant have shown that it is possible by means of the elastic bearing element in a constructively simple manner to release and restrict degrees of freedom of movement in the adjustable arrangement between the tunable optical component and the first folding element. In a particularly simple manner, it is possible to effect a linear adjustment between the tunable optical component and the first folding element and thereby effect an adjustment of the focal plane of the tunable optical component. Preferably, the linear bearing is designed in such a way that it only allows relative adjustment along the linear axis, whereas adjustment along another axis and/or rotation about the other axis, which is perpendicular to the linear axis, is restricted.

In a preferred embodiment, the coil carrier is surrounded by the magnet carrier in a plane on at least two, preferably three, sides. Furthermore, the first folding element is surrounded by the coil carrier in the plane on the two, preferably three, sides.

The arrangement described above allows a particularly compact design of the imaging optical system. Preferably, the coil carrier and the magnet carrier each have a first opening corresponding to each other. Preferably, the optical path runs through said openings and the tunable optical component and impinges the first folding element. Preferably, the coil carrier and the magnet carrier each have a second opening corresponding to each other and through which the optical path runs from the first folding element to the second folding element.

In a preferred embodiment, the coil is arranged on a printed circuit board, preferably a folded printed circuit board that comprises an electrical connector.

The preferred embodiment described above allows a high degree of functional integration. This is due to the fact that the printed circuit board can both be used to design the coil with a precisely adjustable geometry and electrical properties and at the same time can be used to provide an electrical connector for the entire imaging optical system.

In a preferred embodiment, the first folding element is a rigid prism. The second folding element may be a mirror.

In a further preferred embodiment, the second folding element is moveably mounted with respect to the tunable optical component and the second folding element, and wherein an actuator is designed to displace the second folding element with respect to the tunable optical component and the second folding element. A second actuator is designed to tilt the second folding element.

Preferably, the second folding element has the second light entry axis and the second light exit axis. Preferably the second folding element is tiltably mounted about the second light entry axis and/or about the second light exit axis and/or about an axis that is perpendicular to both the second light entry axis and the second light exit axis.

In another preferred embodiment, a displacement of the first folding element with respect to the tunable optical component causes a change of a focal plane of the imaging system, such that the adjustable optical property is the optical power of the tunable lens, and wherein a displacement of the second folding element causes an image stabilisation of the imaging system.

The embodiment described above is advantageous because of a possible separation of functions. While the adjustment of the first folding element can preferably serve to change a focal plane of the tunable component and thereby enable a focusing function of the imaging optical system, the adjustment of the second folding element can serve to achieve the optical image stabilisation. By adjusting the first folding element and the second folding element independently, the actuators can each be compactly designed and optimised for the adjustment movements to be performed by them.

In the following, examples of the present invention and its preferred embodiments are described with reference to the accompanying drawings.

### BRIEF DESCRIPTION OF THE DRAWINGS

FIG. 1 shows an imaging optical system in a schematic side view;

FIG. 2 shows the imaging optical system in a front top view;

FIG. 3 shows the imaging optical system in a partial top view.

### DETAILED DESCRIPTION

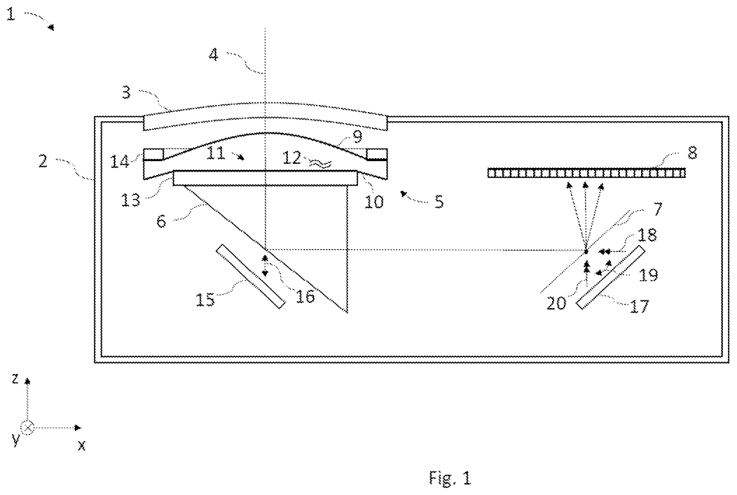

For better understanding, the reference numerals as used in FIGS. 1 to 3 are listed below.
1 Imaging optical system
2 Housing
3 Rigid lens
4 Optical path
5 Tunable optical component
6 First folding element
7 Second folding element
8 Sensor
9 First membrane
10 Second membrane
11 Internal space
12 Transparent liquid
13 Glass window
14 Lens shaping element
15 First Actuator
16 Linear axis
17 Second actuator
18 First tilting axis
19 Second tilting axis
20 Third tilting axis
21 Coil
22 Magnet
23 Coil carrier
24 Magnet carrier
25 Elastic bearing element

An imaging optical system 1, as shown in FIG. 1, can be designed for use in a mobile phone (not shown) and to optically detect an object according to the functionality of a camera. In order to improve the image quality, it is possible to compensate for the negative influence of an unsteady guidance of the mobile phone by performing an autofocus and an optical image stabilization. According to the imaging optical system 1, these functions are possible without affecting a compact design of the imaging optical system 1.

The imaging optical system 1 comprises a housing 2 and a rigid lens 3. The lens 3 allows a light beam to enter the optical imaging system 1 along an optical path 4. The imaging optical system 1 further comprises a tunable optical lens 5, a first folding element 6, a second folding element 7 and an imaging sensor 8 that are arranged in series along the optical path 4.

The tunable optical component 5 comprises a first optical surface 9 and a second optical surface 10, that each are designed as transparent membranes and enclose an internal space 11 of the imaging optical system 1. The tunable optical component 5 comprises an optical axis, which in at least one state of the tunable optical component 5 runs parallel to the optical path 4. Lateral to the optical axis of tunable optical component 5, the internal space 5 is limited by a flexible bellow. Furthermore, the internal space 11 is filled with a transparent liquid 12, which, in the present case, is an optical oil.

The first optical surface 9 and the second optical surface 10 are elastically deformable, such that the internal space 10 is also deformable. By deforming the internal space 11, an optical property of the tunable optical component may be changed. In the present case, said optical property is the focal power of the tunable optical component 5.

A transparent glass window 13 is moveably arranged between the tunable optical component 5 and the first folding element 6 along the optical axis 4. In order to change the focal power of the tunable optical component 5, the glass window 13 can be moved against the second optical surface 10. As a result, the first optical surface 9 abuts against a lens shaping element 14, that has a circumferential geometry and in at least one state of the imaging system 1 extends coaxially about the optical path 4. By moving the glass window against the second optical surface 10, the pressure of the transparent liquid 12 increases and causes the first optical surface 9 to deform. This allows to adjust the focal power of the tunable optical component 5.

In order to achieve a compact design of the optical imaging system 1 as shown in FIG. 1, the glass window 4 is mechanically coupled to the first folding element 6. Since the glass window 4 is mechanically coupled to the tunable optical component 5, the change of the focal power of the tunable optical component 5 can be achieved by moving the first folding element 6 with respect to the tunable optical component 5. Thus, the first folding element 6 is mechanically coupled to the tunable optical component 5 via the glass window 4.

According to the imaging optical system 1 as shown in FIG. 1, the first folding element 6 is a rigid prism and designed to deflect the optical path 4 by 90°. As a result of this deflection, the optical path 4 is directed to the second folding element 7, which is designed as a mirror. In at least one state of the optical imaging system 1, the second folding element 7 is arranged such that the optical path 4 is again deflected by 90° and directed to the imaging sensor 8.

It is an advantage of the imaging optical system 1 that further optical components, such as rigid lenses (not shown), may be arranged between the first folding element 6 and the second folding element 7. If the imaging optical system 1 is used in a mobile phone, the arrangement of said further optical components does not affect a flat design of the phone. Another advantage is that the imaging sensor 8 may be designed with a large sensor area, since the sensor 8 may be arranged parallel to the main extension plane of the mobile phone. Therefore, the sensor 8 also does not affect the flat design of the mobile phone. According to FIG. 1, the optical imaging system 1 extends by not more than 7.2 mm along the z-axis. The width of the imaging sensor 8 is 6 mm with respect to the x-axis.

It is relevant that the first folding element 6 is moveably mounted along a linear axis 16 and may be displaced along said linear axis 16 by a first actuator 15, in order to change the focal power of the tunable optical component 5. The second folding element 7 is tiltably mounted about a first tilting axis 18, a second tilting axis 19 and a third tilting axis 20 and may be tilted about at least one of the tilting axis' 18, 19, 20 by a second actuator 17. By tilting the second folding element 7, the optical path 4 may be adjusted with respect to the imaging sensor 8. This allows to perform an optical image stabilisation. It is advantageous that a change of a focal power and the optical image stabilisation functionality is provided by separated components, namely the first folding element 6 and the first actuator 15 and by the second folding element 7 and the second actuator 17.

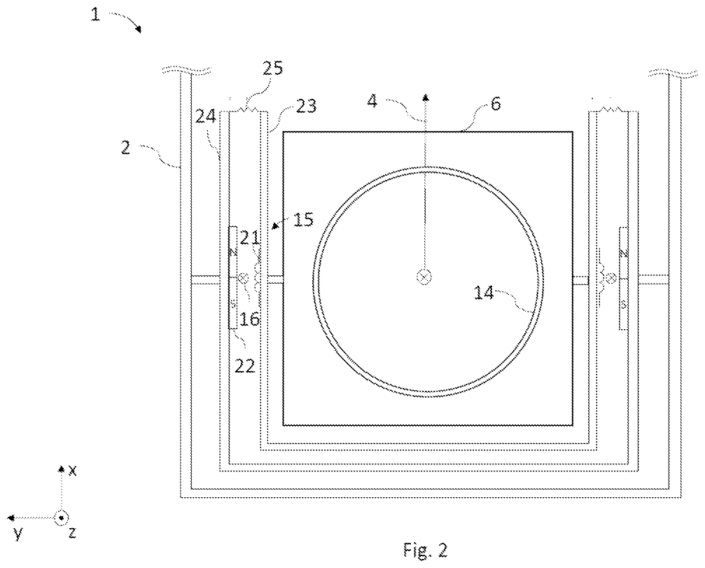

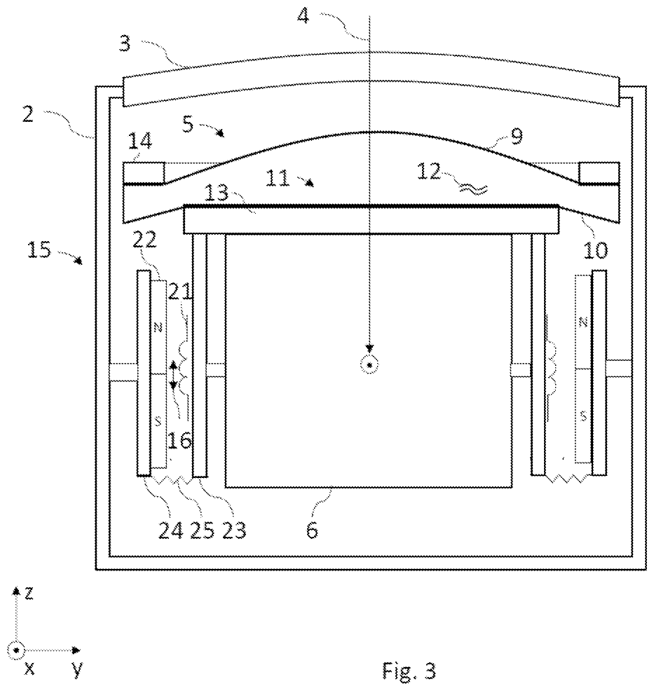

In the following, it described with reference to FIGS. 2 and 3 how the first actuator 15 is designed and how the relative movement between the first folding element 6 and the tunable optical component 5 is achieved.

FIG. 2 shows the imaging optical system 1 from a point of view between the first folding element 6 and the second folding element 7 and directed against the optical path 4 (see FIG. 1). In other words, according to FIG. 2, the optical path 4 passes through the rigid lens 3, the tunable optical component 5 and impinges the first folding element 6, which deflects the optical path 4 such that it projects out of the image plane of FIG. 2.

The first actuator 15 comprises a plurality of coils 21 and magnets 22, that are arranged laterally to the optical path 4. For a better overview, only one coil 21 and only one magnet 22 is provided with a reference number. The coil 21 is arranged on a coil carrier 23 and the magnet 22 is arranged on a magnet carrier 22. The coil carrier 23 is mechanically coupled to the first folding element 6 and the magnet carrier 24 is mechanically coupled to the housing 2.

By generating an electric current in the coil 23, a magnetic field can be generated in a known manner, which interacts with the magnetic field of the magnet 24. The coil 23 and the magnet 22 are oriented in such a way that, depending on the direction of flow of the current, a force is exerted along the linear axis 16. This causes the coil carrier 23 and the first folding element 6 to move along the linear axis 16.

In order to guide the movement of the coil carrier 23 and the first folding element 6, the coil carrier 23 is connected to the magnet carrier 24 via an elastic bearing 25, which is designed as a flat leaf spring.

FIG. 3 shows the imaging optical system 1 looking along the optical path 4 from above the imaging optical system 1. In addition to what is described in relation to FIGS. 1 and 2, it can be seen from FIG. 3 that the lens shaping element 14 has a substantially annular geometry. Furthermore, it can be seen that the first folding element 6 is surrounded on three sides by the coil carrier and the coil carrier is in turn surrounded on three sides by the magnet carrier.

1. Imaging optical system (1) with
a tunable optical component (5), which comprises a first optical surface (9), a second optical surface (10) and a deformable internal space (11) between the first optical surface (9) and the second optical surface (10), which internal space (11) is filled with a transparent liquid (12), and wherein an optical property of the tunable optical component (5) is adjustable by altering a shape of the internal space (11), and with
a first folding element (6), which is mechanically coupled to the tunable optical component (5) such that a relative displacement between the first folding element (6) and the tunable optical component (5) causes a change of the optical property of the tunable optical component (5) and with
a second folding element (7) that is arranged in series with the tunable optical component (5) and the first folding element (6) within an optical path (4) of the imaging optical system (1).

2. Imaging optical system (1) according to claim 1,
with an image sensor (8) that is arranged within the optical path (4), wherein the tunable optical component (5) and the image sensor (8) are essentially arranged parallel to each other and wherein the optical path (4) is preferably folded by essentially 180°.

3. Imaging optical system (1) according to claim 1,
wherein the first folding element (6) is moveably mounted with respect to the tunable optical component (5),
with an actuator (15) comprising a magnet (22) and a coil (21), wherein the magnet (22) is mechanically coupled to the tunable optical element (5) and the coil (21) is mechanically coupled to the first folding element (6)
and wherein the coil (21) and the magnet (22) interact such that an electric current in the coil (21) causes a relative displacement between the first folding element (6) and the tunable optical component (5) in order to change the optical property of the tunable optical component (5).

4. Imaging optical system (1) according to claim 3,
with a lens shaping element (14) that comprises a circumferential edge, which at least partially extends around the optical path (4) and is designed to interact with the first optical surface (9) of the tunable optical component (5),
and with a transparent element (13), particularly a glass window, that is essentially flat and is attached to the second optical surface (10) of the tunable component (5) and the first folding element (6) and wherein
the lens shaping element (14) is mechanically coupled to the magnet (22) and the transparent element (13) is mechanically coupled to the coil (21), such that
the electric current causes a displacement of the transparent element (13) with respect to the lens shaping element (14) in order to change the optical property of the tunable optical component (5).

5. Imaging optical system according (1) to claim 4,
wherein the first optical surface (9) and the second optical surface (1) each are deformable membranes.

6. Imaging optical system according to claim 4,
wherein the coil (21) is arranged on a coil carrier (23) and the magnet (22) is arranged on a magnet carrier (24) and wherein
an elastic bearing element (25) is mechanically coupled to the coil carrier (23) and the magnet carrier (24).

7. Imaging optical system (1) according to claim 6,
wherein the elastic bearing element (25) is an essentially flat spring.

8. Imaging optical system (1) according to claim 6,
wherein the elastic bearing element (25) defines a linear axis (16) of motion for the relative displacement between the tunable optical component (5) and the first folding element (6).

9. Imaging optical system (1) according to claim 8,
wherein the coil carrier (23) is surrounded by the magnet carrier (24) in a plane on at least two, preferably three, sides, and wherein the first folding element (6) is surrounded by the coil carrier (23) in the plane on the two, preferably three, sides.

10. Imaging optical system (1) according to claim 3,
wherein the coil (21) is arranged on a printed circuit board, preferably a folded printed circuit board that comprises an electrical connector.

11. Imaging optical system (1) according to claim 1,
wherein the first folding element (6) and/or the second folding element (7) is a rigid prism or a mirror.

12. Imaging optical system according (1) to claim 1
wherein the second folding element (7) is moveably mounted with respect to the tunable optical component (5) and the second folding element (6),
and wherein a second actuator (17) is designed to move the second folding element (7) with respect to the tunable optical component (5) and the second folding element (7),
and wherein the second actuator (17) is designed to tilt the second folding element (8′7).

13. Imaging optical system (1) according to claim 12,
wherein a displacement of the first folding element (6) with respect to the tunable optical component (5) causes a change of a focal plane of the tunable optical component, such that the adjustable optical property is an optical power of the imaging optical system (1), and wherein a movement of the second folding element (7) causes an image stabilisation of the imaging optical system 1.

14. Imaging optical system (1) according to claim 1,
wherein a depth of the imaging system (1) is not larger than 7.2 mm.

15. Imaging optical system (1) according to claim 2,
wherein the imaging sensor (8) has a width of at least 6 mm.
